(19) United States
(12) Patent Application Publication
(10) Pub. No.: US 2009/0167471 A1
(43) Pub. Date: Jul. 2, 2009

(54) MAGNETICALLY LATCHED MINIATURE SWITCH

(75) Inventors: Naveen Samuel Jesuraj, Bangalore (IN); V. Palanisamy, Bangalore (IN); Karl L. Kitts, Fairview, NC (US); Bernard Victor Bush, Santa Barbara, CA (US)

Correspondence Address: Helen Odar Wolstoncroft, Tyco Technology Resources, 4550 New Linden Hill Road, Suite 140, Wilmington, DE, 19808-2952, US

(73) Assignee: TYCO ELECTRONICS CORPORATION, Middletown, PA (US)

(21) Appl. No.: 11/964,965

(22) Filed: Dec. 27, 2007

(51) Int. Cl. H01H 9/00

(52) U.S. Cl. 335/179

(57) ABSTRACT

A magnetic latch for switches is provided.

### FIELD

The present disclosure relates generally to latching for switches. The present disclosure relates more particularly to magnetic latching of switches.

### BACKGROUND AND SUMMARY

Push button switches provide for toggling of circuits between open and closed states. Such toggling often involves the selective application of pressure to a button. Accordingly, button operation often requires a human presence to effect state change.

According to a first embodiment of the present disclosure, a switch assembly is provided including a normally-open pushbutton switch and an interrupt attachment. The interrupt attachment including a permanent magnet, a magnetically responsive element, and an electromagnet. The permanent magnet, when in close proximity to the magnetically responsive element, applies a magnetic force to the magnetically responsive element to hold the switch in a closed-circuit position. The electromagnet, when energized, applies a magnetic force to the magnetically responsive element that is able to overcome the magnetic force applied by the permanent magnet to allow the switch to return to an open state.

According to a second embodiment of the present disclosure, a switch assembly is provided including a pushbutton switch biased to an open circuit position and an interrupt attachment. The interrupt attachment includes a first magnetic member, a second magnetic member, and a third magnetic member. The first magnetic member attracts the second magnetic member to hold the pushbutton switch in a closed circuit position. The third magnetic member selectively interacts with the second magnetic member to overcome the attraction between the first and second magnetic members to release the pushbutton switch from the closed circuit position.

According to another embodiment of the present disclosure, a switch assembly is provided including a pushbutton switch normally biased to an open circuit position; a latching mechanism configured to hold the switch in a closed circuit position; and an electromagnet configured to disengage the latch mechanism to permit the switch to return to the open circuit position.

### BRIEF DESCRIPTION OF THE DRAWINGS

FIG. 1 is a perspective view of a magnetically latched switch assembly in an open circuit state;

FIG. 2 is an exploded view of the switch assembly of FIG. 1;

FIG. 3 is a perspective view of the switch assembly of FIG. 1 in a closed circuit state

FIG. 4 is an exploded view of a second embodiment magnetically latched switch assembly; and

FIG. 5 is a cross sectional view of the assembled second embodiment switch assembly of FIG. 4.

### DETAILED DESCRIPTION OF DRAWINGS

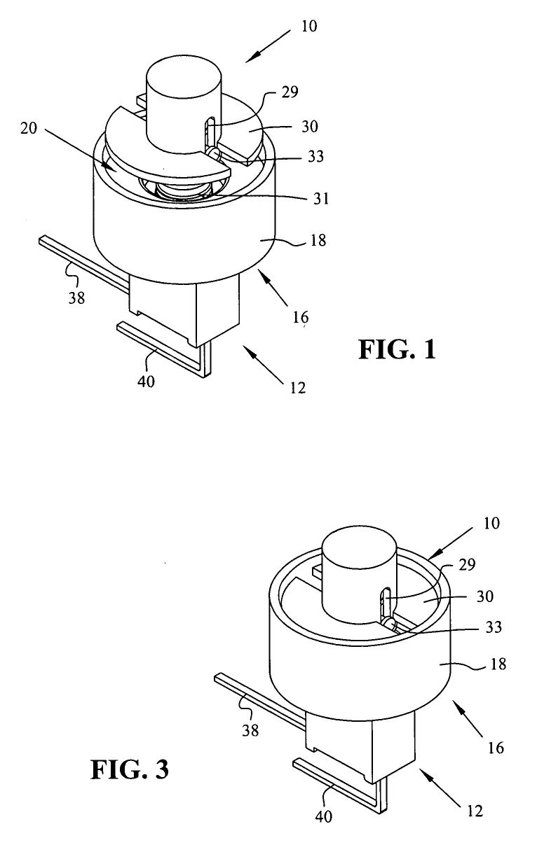

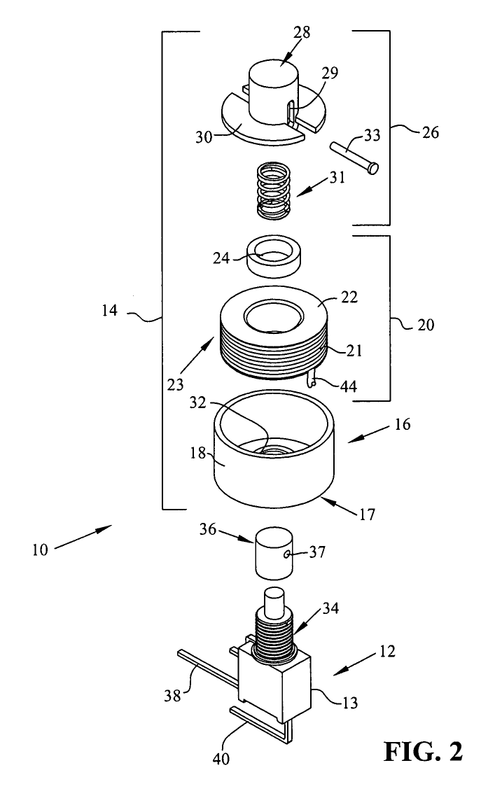

FIG. 1 shows switch assembly 10 that includes miniature switch 12 and interrupt attachment 14. Switch 12 is a basic momentary push to on or off type switch. Switch 12 includes internal biasing member (not shown) that urges button 36 (and thus the switch 12 generally) to an off position that prevents electrical communication between electrical traces coupled to contacts 38, 40. Pressure applied to button 36 allows depression of button 36 and compression of the biasing member (not shown). Such compression allows completion of a circuit to allow an electrical connection between traces coupled to contacts 38, 40. Button 36 includes a substantially horizontal bore 37 therethrough.

Housing 13 of switch 12 includes many sections including externally threaded section 34. Interrupt attachment 14 includes housing 16, electromagnet assembly 20, and button assembly 26.

Housing 16 includes lower end 17 and outer wall 18 shown illustratively constructed from a ferromagnetic material, however other materials may be used. Lower end 17 includes threaded bore 32 sized and shaped to threadably engage threaded section 34 of switch 12.

Electromagnet assembly 20 is located within housing 16. Electromagnet assembly 20 includes electromagnet 23 and permanent magnet 24. Electromagnet 23 includes excitation coil 21 wound about bobbin 22. Both electromagnet 23 and permanent magnet 24 are annular to fit within housing 16. The outer diameter of permanent magnet 24 is substantially equal to the inner diameter of bobbin 22 such that permanent magnet 24 is received within an inner void of electromagnet 23 in assembly. Furthermore, in assembly, upper edges of permanent magnet 24 and bobbin 22 define a common plane.

Button assembly 26 includes button 28 soft iron contact 30, spring 31, and pin 33. Button 28 is fixed to soft iron contact 30 and has substantially vertical slots 29 defined therein. Slots 29 extend from the outer edge of button 28 to an inner void. The inner void is sized to receive button 36 therein. Iron contact 30 is substantially planar and includes opposing gaps proximate slots 29. Slots 29 are on opposing sides of button 28 and are of a width similar to the diameter of horizontal bore 37. Spring 31 is of a diameter that is smaller than the diameter of button 36. Pin 33 is of a length greater than the diameter of button 36 and of a diameter to pass through slots 29 and bore 37.

In assembly housing 16 receives electromagnet 23 and permanent magnet 24 therein. Electromagnet 23 and permanent magnet 24 are glued or are otherwise affixed to lower end 17 of housing 16.

Housing 16 is then threadably attached to switch 12 via threads 32 and 34. Next, button assembly 26 is placed in a generally centered position in housing 16. When so placed, the upper edge of button 36 engages spring 31. Button 28 is rotated and spring 31 is compressed if necessary such that slots 29 align with bore 37. Pin 33 is then passed through slots 29 and bore 37. Accordingly, button assembly 26 is biased upward via spring 31 yet button 28 is retained thereon by pin 33.

FIG. 1 shows switch assembly 10 in a deactivated or tripped state that results in an off condition. When a user presses upon the upper surface of button 28, button assembly 26, as well as button 36 is depressed as shown in FIG. 3. By so pressing, soft iron contact 30 comes in close proximity to permanent magnet 24 and is thus attracted by the magnetism of permanent magnet 24. It should be appreciated that the magnetic force between permanent magnet 24 and soft iron contact 30 is greater than the biasing force of spring 31. Additionally, the biasing force of spring 31 is great enough to depress button 36, by overcoming any biasing force within switch 12. Accordingly, the magnetic interaction of permanent magnet 24 and iron contact 30 holds button 36 in the depressed or on mode. Permanent magnet 24 and iron contact 30 thus form a latch to hold switch 12 in a closed circuit position.

Switch 12 will remain in the on position until a force is applied to button assembly 26 that, along with the force of spring 31, can overcome the magnetic attraction between permanent magnet 24 and soft iron contact 30. Electromagnet assembly 20 can selectively apply such a force to allow deactivation of the switch 12.

Energizing the excitation coil 21 via leads 44 energizes the electromagnet which generates a magnetic force that repels soft iron contact 30 with force that, combined with the force of spring 31 overcomes the magnetic attraction between permanent magnet 24 and soft iron contact 30. Thus, button assembly 26 will then assume the position shown in FIG. 1.

The relative outward protrusion of button 28 relative to housing 16 provides a visual indication of the mode of switch 12. It should be appreciated that leads 44 can be attached to a number of different mechanisms which can serve to indicate a number of different states, including states indicative of ground fault interruption, circuit overload, overspeed, differential position sensing, or a variety of other applications, or electrical signal operation is desired for safety or other reasons and easy re-set of the circuit is desired. One such application includes having contacts 38 and 40 being electrically coupled to a high power relay, such that the high power relay may provide a high power interruption in response to a ground fault or other condition detection communicated to leads 44.

It should be appreciated that as long as electromagnet 23 is energized, additional attempts to depress button 28 will fail to retain button 36 in the on position/mode, but rather the continued energizing of electromagnet 23 will continue to repel soft iron contact 30, thereby urging button assembly 26 upward and allowing button 36 to assume the off position. Additionally, the switch can remain in the closed circuit configuration without having the electromagnet in an energized state.

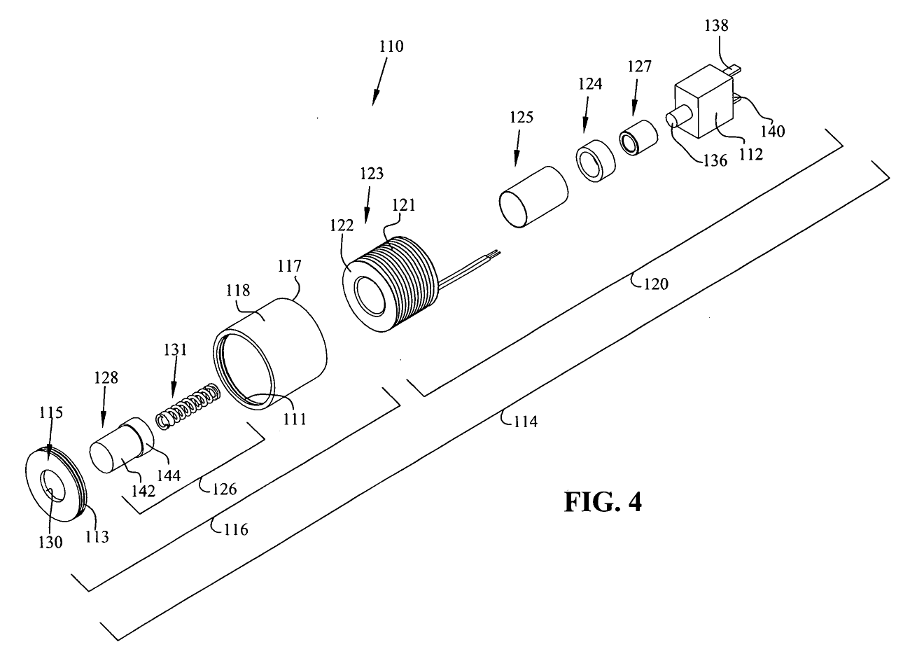

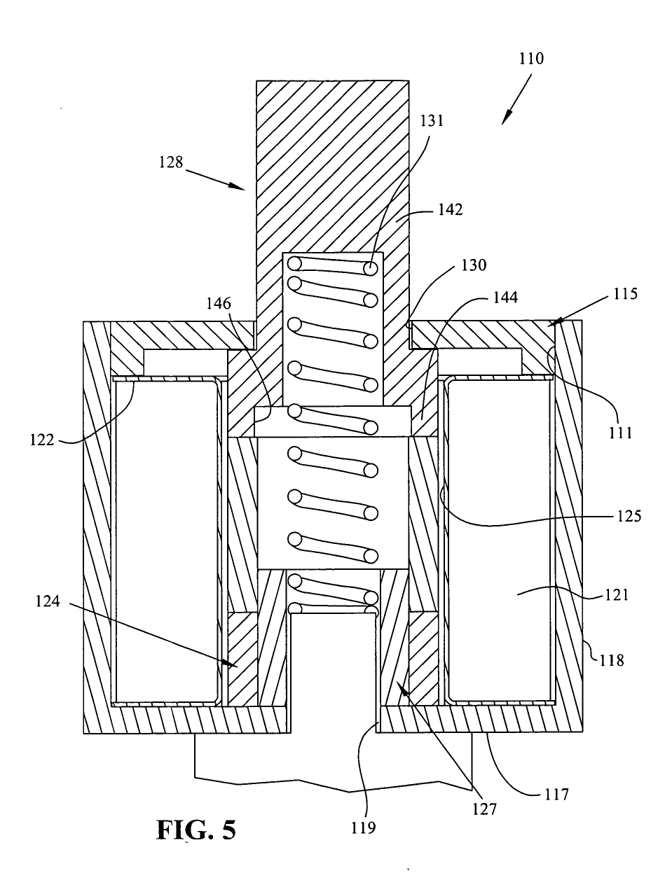

A second embodiment switch assembly 110 is shown in FIGS. 4 and 5. FIG. 4 shows switch assembly 110 that includes miniature switch 112 and interrupt attachment 114. Switch 112 is substantially similar to switch 12. Switch 112 includes internal biasing member (not shown) that urges button 136 (and thus the switch 112 generally) to an off position that prevents electrical communication between electrical traces coupled to contacts 138, 140.

Interrupt attachment 114 includes housing 116, electromagnet assembly 120, and button assembly 126.

Housing 116 includes lower end 117, outer wall 118, and top wall 115 shown illustratively constructed from a ferromagnetic material, however other materials may be used. Lower end 117 includes bore 119 sized and shaped to engage switch 112. Lower end 117 also includes a threaded inner portion 111 sized and shaped to receive a threaded outer rim 113 of top wall 115. Top wall 115 further includes a button bore 130.

Electromagnet assembly 120 is located within housing 116. Electromagnet assembly 120 includes electromagnet 123 permanent magnet 124, bobbin sheath 125, and spring guide 127. Electromagnet 123 includes excitation coil 121 wound about bobbin 122. Both electromagnet 123 and permanent magnet 124 are annular to fit within housing 116. The outer diameter of permanent magnet 124 is substantially equal to the inner diameter of bobbin 122 such that permanent magnet 124 is received within an inner void of bobbin sheath 125 which is received within an inner void of electromagnet 123 in assembly shown in FIG. 5.

Button assembly 126 includes button 128 made of soft iron and spring 131. Button 128 includes an inner void 139 sized to partially receive spring 131 therein. Button 128 includes first diametered portion 142 having a diameter slightly less than button bore 130. Button 128 also includes second diametered portion 144 having a diameter larger than button bore 130 and approximately equal to the outer diameter of permanent magnet 124. Within second diametered portion 144 is guide bore 146 sized to partially receive spring guide 127 therein.

In assembly housing 116 receives electromagnet 123 bobbin sheath 125, permanent magnet 124, and spring guide 127 therein. Electromagnet 123, permanent magnet 124, and spring guide are glued or are otherwise affixed to lower end 117 of housing 116.

Housing 116 is then attached to switch 112 via adhesive or otherwise. Next, button assembly 126 is placed in a generally centered position in housing 116. When so placed, the upper edge of button 136 engages spring 131. Button 128 is compressed if necessary and top wall 115 is coupled to outer wall 118 via threading or otherwise.

When button 128 is depressed, it contacts and is magnetically held to permanent magnet 124. In such a depressed state, button 128 is mostly within electromagnet 123. Accordingly, activation of electromagnet 123 acts on magnetically sensitive button 128 to overcome the connection with permanent magnet 124. Spring 131 is chosen to have a spring coefficient such that button 136 is depressed when button 128 is depressed and button 136 is not depressed when button 128 is not depressed. Assembly 110 thus operates similarly to assembly 10.

1. A switch assembly including:
a normally-open pushbutton switch; and
an interrupt attachment including a permanent magnet, a magnetically responsive element, and an electromagnet, the permanent magnet, when in close proximity to the magnetically responsive element, applying a magnetic force to the magnetically responsive element to hold the switch in a closed-circuit position, the electromagnet, when energized, applying a magnetic force to the magnetically responsive element that is able to overcome the magnetic force applied by the permanent magnet to allow the switch to return to an open state.

2. The assembly of claim 1, wherein the interrupt attachment threadably engages the switch.

3. The assembly of claim 1, wherein the magnetically responsive element is constructed from iron.

4. The assembly of claim 1, wherein each of the permanent magnet, electromagnet, and magnetically responsive are substantially annular.

5. The assembly of claim 1, wherein the permanent magnet and the electromagnet are fixed and the magnetically responsive element is able to move towards and away from the permanent magnet and electromagnet.

6. The assembly of claim 1, wherein the magnetically responsive element is externally viewable to indicate the open or closed status of the switch.

7. The assembly of claim 1, wherein the electromagnet is normally non-energized.

8. A switch assembly including:
a pushbutton switch biased to an open circuit position; and
an interrupt attachment including a first magnetic member, a second magnetic member, and a third magnetic member, the first magnetic member attracting the second magnetic member to hold the pushbutton switch in a closed circuit position, the third magnetic member selectively interacting with the second magnetic member to overcome the attraction between the first and second magnetic members to release the pushbutton switch from the closed circuit position.

9. The assembly of claim 8, wherein the third magnetic member is an electromagnet that is selectively energized.

10. The assembly of claim 8, wherein the interrupt attachment threadably engages the switch.

11. The assembly of claim 8, wherein the first magnetic member is a permanent magnet.

12. The assembly of claim 8, wherein the second magnetic member is constructed from iron.

13. The assembly of claim 8, wherein each of the first, second, and third magnetic members are substantially annular.

14. The assembly of claim 8, wherein the first and second magnetic members are fixed and the third magnetic element is able to move towards and away from the first and second magnetic members.

15. The assembly of claim 8, wherein the second magnetic element is externally viewable to indicate the open or closed status of the switch.

16. The assembly of claim 8, wherein the third magnetic element is an electromagnet that is normally non-energized.

17. The assembly of claim 8, wherein the switch remains in its selected closed or open state absent external input.

18. A switch assembly including:
a pushbutton switch normally biased to an open circuit position;
a latching mechanism configured to hold the switch in a closed circuit position; and
an electromagnet configured to disengage the latch mechanism to permit the switch to return to the open circuit position.

19. The assembly of claim 18, wherein the latch includes a permanent magnet and a magnetically responsive element.

20. The assembly of claim 19, wherein the magnetically responsive element is a substantially disk-shaped piece of iron.
